(19) United States
(12) Patent Application Publication
(10) Pub. No.: US 2010/0021762 A1
(43) Pub. Date: Jan. 28, 2010

(54) METALLIC DECORATIVE PART AND MANUFACTURING METHOD FOR THE SAME

(75) Inventors: JING-PING ZHENG, Shenzhen City (CN); HONG-ZHAN YI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/406,180

(22) Filed: Mar. 18, 2009

(30) Foreign Application Priority Data
Jul. 25, 2008 (CN) 200810303073.2

(51) Int. Cl. B32B 15/01; B29C 65/48; B26D 11/00

(52) U.S. Cl. 428/687; 156/196; 83/862

(57) ABSTRACT

A metallic part made from a metallic plate by a punching process, includes a highly reflective first surface, a second surface opposite to the first surface, and a side surface connecting the first surface to the second surface. The first surface is high reflective. The first surface and the side surface cooperatively form a sharp-cornered edge in a boundary thereof. The side surface has a plurality of milling traces.

### BACKGROUND

1. Technical Field

The present disclosure relates to a metallic decorative part and a manufacturing method for the same.

2. Description of the Related Art

Recently, electronic devices, such as mobile phones, notebook computers, and personal digital assistants, are widely used. These electronic devices generally include housings having colorful and beautiful decorative surfaces. The decorative surfaces may be highly reflective.

Referring to FIGS. 6 and 7, a typical metallic decorative part 80 is formed by a punching mold assembly 70 including a first mold 701 and a second mold 702 opposite to the first mold 701. The metallic part 80 includes a first surface 801, a second surface 802 opposite to the first surface 801, and a side surface 803 connecting the first surface 801 to the second surface 802.

In the punching process, the first surface 801 becomes rough because the first mold 701 presses the first surface 801. The side surface 803 often forms a plurality of burrs 804 adjacent to the first surface 801 because of shear stresses F₁, F₂. In addition, a portion 805 of the second surface 802 adjacent to the side surface 803 often is rounded and depressed, resulting in a poor appearance and unsuitable for use as a decorative surface. Therefore, only the first surface 801 can be used as a decorative surface. However, a complex polishing process is needed to polish the first surface 801 and the side surface 803, resulting in an undesirable flatness and thicknesses of the metallic part 80.

Therefore, a new metallic decorative part and a manufacturing method for the same are desired in order to overcome the above-described shortcomings.

### BRIEF DESCRIPTION OF THE DRAWINGS

The components in the drawings are not necessarily drawn to scale, the emphasis instead being placed upon clearly illustrating the principles of the present disclosure.

FIG. 1 is an isometric view of an embodiment of a metallic part.

FIG. 2 is a cross-sectional view taken along the line II-II in FIG. 1.

FIG. 3 is a flow chart of an embodiment of a method of manufacturing the metallic part in FIG. 1.

FIG. 4 is a process of manufacturing the metallic part.

FIG. 5 is schematic view of forming the metallic part by a punching process in FIG. 3.

FIG. 6 is a schematic view of forming a conventional metallic part by a punching mold assembly punching a metal plate.

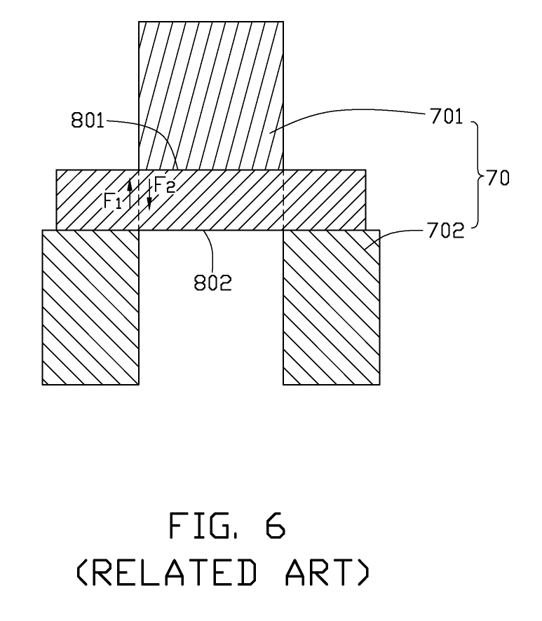

FIG. 7 is a cross-sectional view of the conventional metallic part made from the metal plate in FIG. 6.

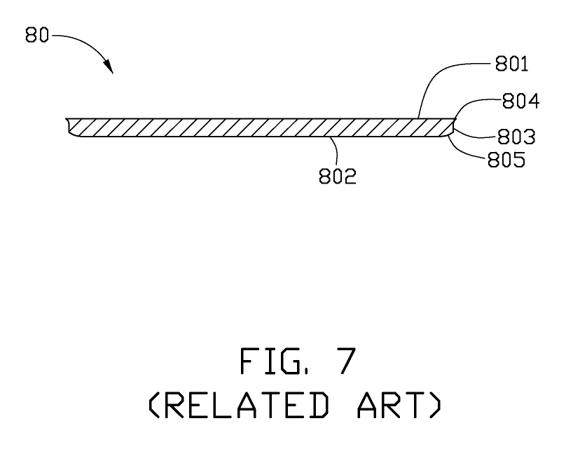

### DETAILED DESCRIPTION

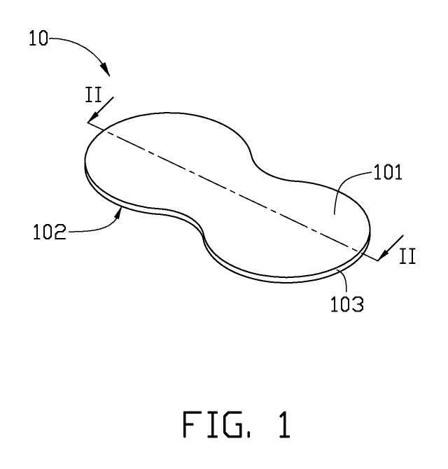

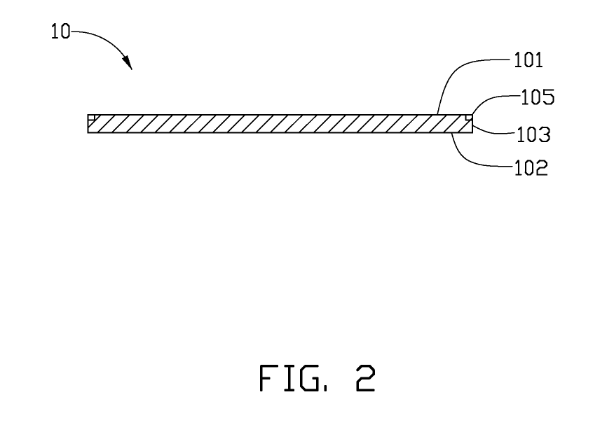

Referring to FIGS. 1 and 2, a metallic part 10 may be a plate-like shape. The metallic part 10 includes a first surface 101, a second surface 102 opposite to the first surface 101, and a side surface 103 connecting the first surface 101 to the second surface 102. The first surface 101 may be a mirror-like flat surface which is generally highly reflective. The first surface 101 may be achieved by using a polishing process. The side surface 103 is substantially perpendicular to the first surface 101 and has a plurality of milling traces. In addition, an edge 105 for connecting the side surface 103 and the first surface 101 is a sharp-cornered edge.

The metallic part 10 may be made of a metallic plate which has a mirror-like flat surface. A material of the metallic part 10 may be for example, stainless steel or copper. In the illustrated embodiment, the metallic part 10 is made of stainless steel. It may be understood that, the metallic part 10 may also be arc-shaped.

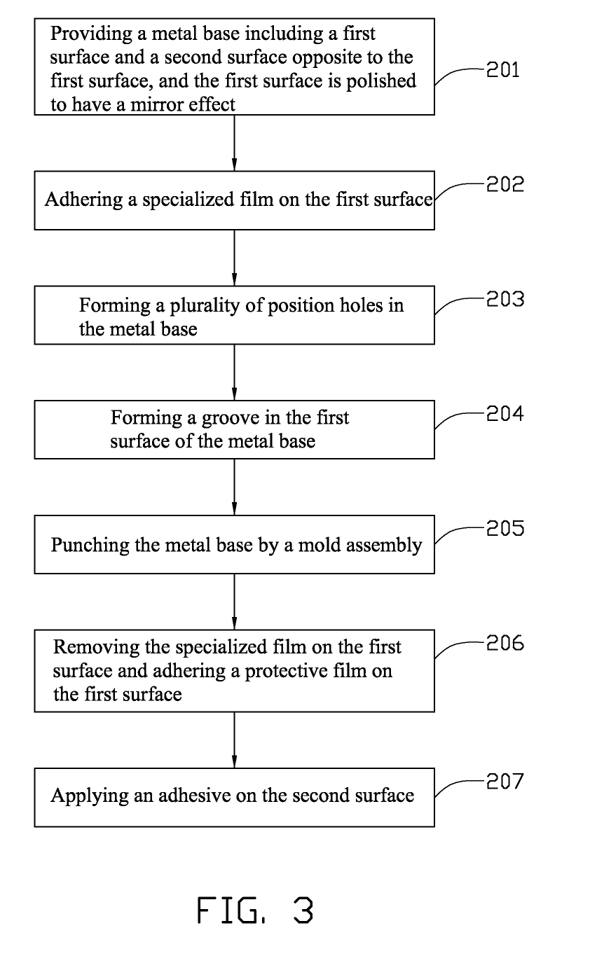

FIG. 3 is a flowchart illustrating an embodiment of a method for manufacturing the metallic part 10. Depending on the embodiment, certain of the steps described below may be removed, others may be added, and the sequence of steps may be altered.

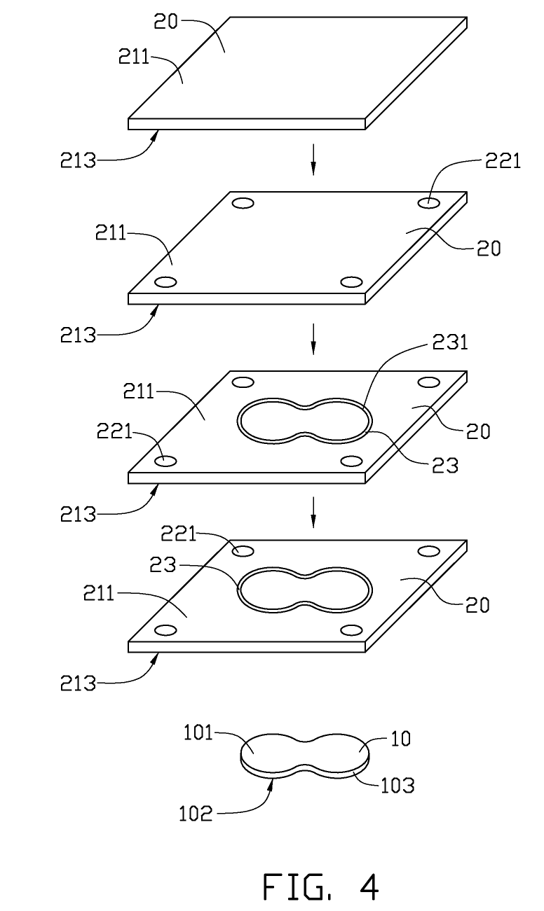

Referring to FIG. 4, in step 201, a metal plate 20 is provided. The metal plate 20 includes a first surface 211 and a second surface 213 opposite to the first surface 211. The first surface 211 is polished to be a mirror-like surface. The first surface 211 may be processed to form a decorative configuration, such as a logo, on the first surface 211. In the illustrated embodiment, the first surface 211 is burnished with a sand paper and a cloth wheel in that order, to reduce a roughness of the metal plate 20 until the first surface 211 is smooth and highly reflective.

It may be understood that, if a surface of the metal plate 20 is already a mirror-like surface, the polishing process may be omitted.

In step 202, a specialized film is adhered on the first surface 211 to prevent the first surface 211 from being damaged during the following process.

In step 203, a plurality of position holes 221 are punched or drilled in the metal plate 20. The position holes 221 may be adjacent to two sides of the metal plate 20 for locating the metal plate 20.

In step 204, a groove 23 may be formed in the first surface 211 of the metal plate 20 by a numerical control (NC) milling device (not shown). An outline of the sidewall 231 of the groove 23 corresponds to an outline of the metallic part 10. A ratio of the depth of the groove 23 with respect to the thickness of the metal plate 20 is larger than ⅓. In the illustrated embodiment, the ratio of the depth of the groove 23 with respect to the thickness of the metal plate 20 is about ½ to about ⅔. In this range, the groove 23 may be formed easily and the first surface 101 has a nice flatness.

In the illustrated embodiment, the position holes 221 of the metal plate 20 are sleeved on the positioning pins of the NC milling device, so that the metal plate 20 is fixed on a worktable of the NC milling device. A milling blade is driven to mill the first surface 211 of the metal plate 20, thereby forming the groove 23. A sidewall 231 of the groove 23 forms a side surface of the metallic part 10, so that a side surface 103 of the metallic part 10 has a plurality of milling traces.

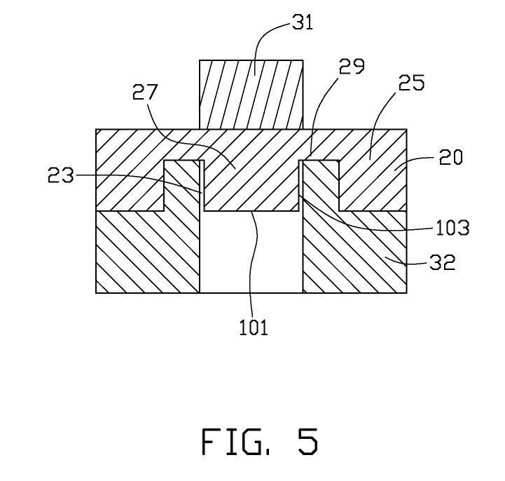

Referring also to FIG. 5, in step 205, a mold assembly (not labeled) is provided. The mold assembly includes a first mold 31 and a second mold 32 opposite to the first mold 31. The first mold 31 has a shape corresponding to the outline of the metallic part 10. The first mold 31 is capable of being moved to contact the second mold 32. The metal plate 20 is fixed on the second mold 32 in such a manner that an opening of the groove 23 faces the second mold 32. The first mold 31 is moved towards the second mold 32. Once the first mold 31 touches the metal plate 20, a periphery of a preforming portion 27 deforms. The first mold 31 moves until the remaining portion 25 and the preforming portion 27 are separated, thus yielding the metallic part 10.

A material of a connecting portion 29 between the preforming portion 27 and the remaining portion 25 is reduced because of the groove 23, the preforming portion 27 is easily separated from the metal plate 20, and the yield rate is enhanced. Since the first surface 211 is separated by a space from the connecting portion 29, a deformation of the first surface 211, which will become the first surface 101 of metallic part 10, is reduced or eliminated. Additionally, the first surface 101 is substantially perpendicular to the side surface 103 such that the first surface 101 and the side surface 103 cooperatively define a sharp-cornered edge. Furthermore, even if the side surface 103 forms a plurality of burrs, the burrs are adjacent to the second surface, so that after the metallic part 10 is assembled to an electronic device, the burrs are hidden from view.

In step 206, the specialized film on the first surface 101 of the metallic part 10 is removed and a protective film is adhered on the first surface 101.

In step 207, an adhesive may be coated on the second surface so that the metallic part 10 can be adhered onto other components.

It should be pointed out that the specialized film prevents the first surface from being scratched. In addition, if there are gas holes, cracks or impurities in the first surface, after the step 201, the gas holes, cracks or impurities are exposed and can be easily spotted by visual examination. It may be understood that, the metal plate 20 may be other shaped such as arc-shaped.

Finally, while various embodiments have been described and illustrated, the embodiments are not to be construed as being limited thereto. Various modifications can be made to the embodiments by those skilled in the art without departing from the true spirit and scope of the embodiments as defined by the appended claims.

What is claimed is:

1. A metallic part, comprising a highly reflective first surface, a second surface opposite to the first surface, and a side surface connecting the first surface to the second surface, wherein the metallic part is made from a metallic plate by a punching process; the first surface and the side surface cooperatively form a sharp-cornered edge in a boundary thereof, the side surface has a plurality of milling traces.

2. The metallic part as claimed in claim 1, wherein a material of the metallic part is stainless steel or copper.

3. The metallic part as claimed in claim 1, wherein the metallic part is plate-shaped.

4. A manufacturing method for a metallic part, the method comprising:
providing a metal plate having a highly reflective first surface and a second surface opposite to the first surface;
forming a groove in the first surface corresponding to an outline of the metallic part by a milling device, wherein a ratio of a depth of the groove with respect to a thickness of the metallic plate is larger than ⅓;
punching the metallic plate along the groove, thereby forming the metallic part.

5. The manufacturing method as claimed in claim 4, wherein the ratio of the depth of the groove with respective to the thickness of metallic plate is about ½ to about ⅔.

6. The manufacturing method as claimed in claim 4, wherein the first surface has been polished.

7. The manufacturing method as claimed in claim 6, further comprising a step of adhering a protective film on the first surface before forming the groove.

8. The manufacturing method as claimed in claim 4, wherein a material of the metallic plate is stainless steel or copper.

9. The manufacturing method as claimed in claim 4, further comprising a step of adhering a protective film on the first surface before forming the groove, and a step of applying an adhesive on the second surface after the punching.

10. The manufacturing method as claimed in claim 4, wherein the metallic plate is punched by a mold assembly, the mold assembly comprising a first mold and a second mold opposite to the first mold; the first mold is movable towards the second mold; the metallic plate is fixed on the second mold in such a manner that an opening of the groove faces the second mold before the first mold moves towards the second mold.

11. A manufacturing method for a metallic part, the method comprising:
providing a stainless steel plate having a mirror-like first surface and a second surface opposite to the first surface;
forming a groove in the first surface corresponding to an outline of the metallic part by a milling device, wherein a ratio of a depth of the groove with respect to a thickness of the metallic plate is about ½ to about ⅔;
punching the metallic plate along the groove, thereby forming the metallic part.

13. The manufacturing method as claimed in claim 11, further comprising a step of adhering a protective film on the first surface after forming a groove and before the punching process

14. The manufacturing method as claimed in claim 11, further comprising a step of applying an adhesive on the second surface after the punching.

15. The manufacturing method as claimed in claim 11, wherein the metallic plate is punched by a mold assembly, the mold assembly comprising a first mold and a second mold opposite to the first mold; the first mold is movable towards the second mold; the metallic plate is fixed on the second mold in such a manner that an opening of the groove faces the second mold before the first mold moves towards the second mold.
